(19) United States
(12) Patent Application Publication
(10) Pub. No.: US 2025/0064059 A1
(43) Pub. Date: Feb. 27, 2025

(54) SUPERPARAMAGNETIC NANOPARTICLES (SPION)-BASED PESTICIDE COMPOSITION

(71) Applicant: KING FAHD UNIVERSITY OF PETROLEUM AND MINERALS, Dhahran (SA)

(72) Inventors: Safyan Akram KHAN, Dhahran (SA); Shahid ALI, Dhahran (SA); Layan Mohammed NOORWALI, Jeddah (SA); Muhammad MANSHA, Dhahran (SA)

(73) Assignee: KING FAHD UNIVERSITY OF PETROLEUM AND MINERALS, Dhahran (SA)

(21) Appl. No.: 18/455,672

(22) Filed: Aug. 25, 2023

(51) Int. Cl. A01N 43/20; A01N 25/26; A01N 25/32

(52) U.S. Cl. CPC A01N 43/20; A01N 25/26; A01N 25/32

(57) ABSTRACT

A method of applying a pesticide composition to a target surface, including contacting the pesticide composition with the target surface; and leaving the pesticide composition on the target surface for a period of time. The pesticide composition includes a pesticide; and superparamagnetic iron oxide nanoparticles (SPIONs). An outer surface of the SPIONs have at least one coating selected from the group consisting of a polyethylene glycol, a compound with a carbon chain having up to 30 carbon atoms, a silane, and an aminosilane with a primary amine group to form coated SPIONs, where the pesticide interacts with the at least one coating on the coated SPIONs, and where the SPIONs are substantially spherical and have an average diameter of 10-30 nm.

### STATEMENT OF ACKNOWLEDGEMENT

Support provided by King Fahd University of Petroleum and Minerals (KFUPM) is gratefully acknowledged.

### BACKGROUND

### Technical Field

The present disclosure is directed to superparamagnetic iron oxide nanoparticles (SPIONs), particularly to a method of applying a pesticide composition including SPIONs to a target surface.

### Description Of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention. Pesticides are used to prevent, incapacitate, or kill unwanted plants or animals which cause problems in growing, process, or storing food. Moreover, pests can damage crops at any stage in the long chain of agricultural production. Pests can harm; (i) seeds when they are sown, (ii) plants while they are green and fragile, (iii) grains as they develop or are about to ripen, and (iv) harvested or stored grains. Pests are estimated to cause 5 to 40% of crop losses each year. The most common pesticides include herbicides, insecticides, fungicides, and slimicides. With the growing human population, it is difficult to meet food demands without the use of pesticides.

Along with numerous benefits, pesticides also have several drawbacks. Over the years, the widespread use of pesticides, especially residue pesticides, has caused a variety of adverse effects on the environment, human health, animals, and aquatic life. A residue pesticide is the remaining amount of pesticides on the crops or food after being treated/sprayed. The maximum acceptable levels of these residues in foods are often stipulated by regulatory bodies in many countries. Regulations such as pre-harvest intervals also often prevent the harvest of crop or livestock products, if recently treated, to allow residue concentrations to decrease over time to safe levels before harvest.

Exposure of the general population to these residues most commonly occurs through the consumption of treated food sources or being in close contact with areas treated with pesticides, such as farms and storage houses. The damages related to human health caused by exposure to pesticides include neurobehavioral alterations, hearing loss, cancer, abnormal respiratory functions, birth defects, and even fetal deaths. One of the major challenges is that the long-term effects of pesticide exposure may not become apparent for several months or even years after exposure, which poses a major obstacle to accountability and access to an effective remedy, including preventive interventions.

Pesticides also raise serious concerns related to the environment. It is estimated that over 98% of sprayed insecticides and 95% of herbicides reach a destination other than their target species, including non-target species, air, water, and soil. The spread of pesticides in the air, soil, and flowers adversely affects pollinators, such as bees and birds. Pesticides can affect coral reproduction, growth, and other physiological processes. Herbicides can affect symbiotic algae and damage their partnership with coral, which results in bleaching. The accumulation of pesticides in sea-foods is also blamed for various medical complications for consumers. International organizations have adopted several resolutions and programs to combat the negative effects of pesticide use over the past decades. Despite various efforts to overcome the effects of pesticides, global pesticides use has increased.

Recently, researchers have been developing methods to remove pesticides from the environment using various nanomaterials. One method includes coating magnetic particles with pesticide-adsorbing polymers to collect the pesticides from water. These adopted approaches can be demonstrated in laboratory experiments but are challenging to implement in real-field applications. Another option is to use pesticides made of superparamagnetic iron oxide nanoparticles (SPIONs, Fe₃O₄). The magnetite nanoparticles (Fe₃O₄ NPs) have several advantages, such as high Curie temperature and maximum saturation magnetization.

Although a few SPION-based magnetic nano-pesticides have been developed in the art, there still exists a need to develop SPION-based pesticides with improved pesticide delivery systems and enhanced re-utilization efficiency. It is one object of the present disclosure to provide a method of applying a pesticide including SPIONs. It is another object of the present disclosure to remove the applied pesticide including the SPIONs.

### SUMMARY

A method of applying a pesticide composition to a target surface is described. The method includes contacting the pesticide composition with the target surface, and leaving the pesticide composition on the target surface for a period of time. The pesticide composition includes a pesticide; and superparamagnetic iron oxide nanoparticles (SPIONs). An outer surface of the SPIONs has at least one coating selected from the group consisting of a polyethylene glycol, a compound with a carbon chain having up to 30 carbon atoms, a silane, and an aminosilane with a primary amine group to form coated SPIONs. The pesticide interacts with the at least one coating on the coated SPIONs, and wherein the SPIONs are substantially spherical and have an average diameter of 10-30 nm.

In some embodiments, the pesticide composition comprises 1-20 wt. % of the pesticide, based on a total weight of the pesticide composition.

In some embodiments, the SPIONs are aggregated forming an interconnected network.

In some embodiments, the at least one coating is polyethylene glycol or the compound with the carbon chain having up to 30 carbon atoms. When the at least one coating is polyethylene glycol or the compound with the carbon chain having up to 30 carbon atoms, the pesticide composition is made by a method including spraying the pesticide on the coated SPIONs, and drying for at least 3 hours to form the pesticide composition. The pesticide interacts with the coated SPIONs through at least one physical interaction selected from van der Waals forces, hydrogen bonding, and hydrophobic interactions.

In some embodiments, the at least one coating is polyethylene glycol and the aminosilane with a primary amine group. When the pesticide is an epoxide-containing pesticide, and the at least one coating is polyethylene glycol and aminosilane with a primary amine group, the pesticide composition is made by a method comprising: dispersing the coated SPIONs in a solvent to form a dispersion; mixing the epoxide-containing pesticide into the dispersion and stirring for at least 3 hours at a temperature of 50-100° C.; and removing the solvent to form the pesticide composition. The pesticide is attached to the coated SPIONs by a chemical bond between the primary amine group of the aminosilane and the epoxide group of the pesticide.

In some embodiments, the at least one coating is polyethylene glycol and silane, and wherein the silane has a thickness of 2-10 nm around the outer surface of the SPIONs. In some embodiments, the silane is porous with an average pore size of 1-10 nm. In some embodiments, the pesticide is present in the pores of the silane in the pesticide composition.

In some embodiments, the pesticide composition does not undergo sedimentation and remains dispersed in a solution for at least 30 minutes.

In some embodiments, the pesticide composition remains stable for at least 30 days under ambient conditions.

In some embodiments, the pesticide is selected from the group consisting of imiprothrin, cypermethrin, dieldrin, and derivatives thereof.

In some embodiments, the method further includes bringing a magnet close enough to the target surface to interact with the pesticide composition on the target surface, wherein the pesticide composition attaches to the magnet, and wherein at least 90% of an initial amount of the pesticide composition attaches to the magnet.

In some embodiments, at least 95% of an initial amount of the pesticide composition attaches to the magnet.

In some embodiments, the period of time is 1 hour to 100 days.

In some embodiments, the compound with a carbon chain having up to 30 carbon atoms is oleic acid or oleyl amine.

In some embodiments, the silane with a primary amine is 3-aminopropyl triethoxysilane.

The foregoing general description of the illustrative present disclosure and the following. The detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic illustration depicting attachment of pesticides to superparamagnetic iron oxide nanoparticles (SPIONs) via adsorption and chemical linkers, according to certain embodiments;

FIG. 1B is a flowchart depicting a method of applying a pesticide composition to a target surface, according to certain embodiments;

FIG. 2A is a schematic illustration depicting the synthesis of hydrophilic SPIONs (polyethylene glycol/PEG-Fe₃O₄) and hydrophobic SPIONs (oleic acid and oleylamine/OLA-Fe₃O₄), according to certain embodiments;

FIG. 2B is a schematic illustration depicting synthesis of uncoated SPIONs (UC-Fe₃O₄), according to certain embodiments;

FIG. 2C is a schematic illustration depicting synthesis of silane encapsulation of the hydrophilic SPIONs, PEG-Fe₃O₄, according to certain embodiments;

FIG. 3 is a schematic representation for synthesis of dieldrin-attached Fe₃O₄@SiO₂-NH₂, according to certain embodiments;

FIG. 4A depicts X-ray diffractogram (XRD) patterns of PEG-Fe₃O₄, OLA-Fe₃O₄, and UC-Fe₃O₄ NPs, according to certain embodiments;

FIG. 4B depicts a comparison of diffraction patterns for PEG-Fe₃O₄ and PEG-Fe₃O₄@SiO₂ NPs, according to certain embodiments;

FIG. 5 shows Fourier Transform Infrared (FTIR) spectra of the PEG-Fe₃O₄, OLA-Fe₃O₄, and UC-Fe₃O₄ NPs, according to certain embodiments;

FIG. 6A-FIG. 6C shows high-resolution field emission scanning electron microscope (FESEM) images of PEG-Fe₃O₄, OLA-Fe₃O₄, and UC-Fe₃O₄ NPs, according to certain embodiments;

FIG. 6D shows a transmission electron microscope (TEM) image of PEG-Fe₃O₄ NPs after coating with silane (PEG-Fe₃O₄@SiO₂), according to certain embodiments;

FIG. 7A shows sedimentation behavior of PEG-Fe₃O₄ using turbiscan measurements for 0-30 minutes, according to certain embodiments;

FIG. 7B shows sedimentation behavior of OLA-Fe₃O₄ using turbiscan measurements for 0-30 minutes, according to certain embodiments;

FIG. 7C shows sedimentation behavior of UC-Fe₃O₄ NPs using turbiscan measurements for 0-30 minutes, according to certain embodiments;

FIG. 8 shows the functionality and structural stability tests of PEG-Fe₃O₄, OLA-Fe₃O₄, and UC-Fe₃O₄ in de-ionized water and oil phases (1:1) in the presence of a magnetic field, according to certain embodiments;

FIG. 9A shows FTIR spectra of insecticide-coated PEG-Fe₃O₄ and herbicide-coated OLA-Fe₃O₄ NPs after one month of coating, according to certain embodiments;

FIG. 9B shows FTIR spectra of dieldrin-attached Fe₃O₄@SiO₂-NH₂ after one month of coating, according to certain embodiments; and

FIG. 10 is a pictorial representation demonstrating spraying and collection of pesticide-coated SPIONs on a uniform grassy field, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is 30 /−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise.

Where a numerical limit or range is stated herein, the endpoints are included. Also, all values and subranges within a numerical limit or range are specifically included as if explicitly written out.

Aspects of the present disclosure are directed to superparamagnetic nanoparticles (SPIONs)-based pesticide compositions for recovery of pesticide pollutants to improve pesticide utilization efficiency. For this purpose, reusable hydrophilic and hydrophobic SPIONs were synthesized by a solvothermal method followed by coating with silane to enhance the surface reactivity for chemical attachment with pesticides.

A pesticide composition is described. The pesticide composition includes at least one pesticide and SPIONs. The pesticide may include insecticides, herbicides, fungicides, rodenticides, organophosphates, captans, neonicotinoids, disinfectants, attractants, plant defoliants, swimming pool treatments, plant growth regulators, algicides, antifoulants, antimicrobials, biopesticides, biocides, defoliants, desiccants, disinfectants, sanitizers, fumigants, insect growth regulators, miticides, microbial pesticides, molluscicides, nematicides, ovicides, pheromones, plant growth regulators, plant-incorporated protectants, repellents, rodenticides, slimicides, synthetic pesticides, or a mixture thereof.

Suitable examples of pesticides include amidosulfuron, flazasulfuron, metsulfuron-methyl, rimsulfuron, sulfometuron-methyl, terbacil, nicosulfuron, and triflusulfuron-methyl, allethrin, cypermethrin, glyphosate, acephate, deet, popoxur, metaldehyde, boric acid, diazinon, dursban, DDT, malathion, pentachlorophenol, 2,4-D, teknar, rozol, chlorinated hydrocarbons (kelthane), carbamates, organophoshates, pyrethroids, O-S Dimethyl acetylphosphoramidothioate, thiamethoxam, imidacloprid, indoxacarb, imidacloprid, chlorantraniliprole, profenofos, cypermethrin, deltamethrin, chlorpyrifos, quinolphos, flubendiamide, carbofuron, triazophos, fipronil, lambda-cyhalothrin, dicofol, methomyl, thiodicarb, fenazaquin, malathion, carbosulfan, oxidematon methyle, dichlorvos, monocrotrophos, spiromesifen, diafenthiuron, emamectin benzoate, fipronil, acetamiprid, dimethoate, carbaryl, phorate, abamectin, sulfur, fosetyl-AL, azyoxystrobin, aureofungin, tricyclazole, carbendaziem, triadimefon, benomyl, COC, tridemorph, captan, hexaconozole, ziram, tebucnazole, indofil, chlorthalonil, dinocap, copper hydroxide, iprodione, fenarimol, propiconozole, penconazole, azospirillum, azotobacter, pendimethalin, glyphosate, oxyfluorfen, paraquat dichloride, or a mixture thereof.

In a preferred embodiment, the pesticide is selected from a group of imiprothrin, cypermethrin, dieldrin, and derivatives thereof. The pesticide is present in an amount ranging from 1-40 wt. %, preferably 5-30 wt. %, preferably 10-25 wt. %, or preferably 15-20 wt. % based on the total weight of the pesticide composition.

The pesticide composition further includes SPIONs. SPIONs are preferably iron oxide (Fe₃O₄) nanoparticles. They are well-known in the art and can be obtained by various methods, see for example U.S. Pat. Nos. 9,161,996 and 8,962,031—both incorporated herein by reference in their entirety, and Szpak et al. [“Stable aqueous dispersion of supermagnetic iron oxide nanoparticles protected by charged chitosan derivatives” J. Nanopart. Res (2013) 15 (1), 1372—incorporated herein by reference in its entirety]. In some embodiments, the SPIONs are co-doped and have a magnetic ferrite of formula MFe₂O₄ where M is at least one transition metal selected from the group consisting of Cu, Ni, Co, and Mn. In some embodiments, the magnetic ferrite is a mixed metal or doped metal ferrite of formula M₁₋ₓAₓFe₂O₄, where A represents a transition metal or rare earth element and 0<x≤0.5. Examples of such mixed meal or doped metal ferrites include Mn_{0.5}Zn_{0.5}Fe₂O₄. In a preferred embodiment, the SPIONs consist of Fe₃O₄. In a preferred embodiment, the Fe₃O₄ has a spinel or inverse spinel structure.

In general, the SPIONs can be any shape known to one of ordinary skill in the art. Examples of suitable shapes the SPIONs may take include spheres, spheroids, lentoids, ovoids, solid polyhedra such as tetrahedra, cubes, octahedra, icosahedra, dodecahedra, hollow polyhedral (also known as nanocages), stellated polyhedral (both regular and irregular, also known as nanostars), triangular prisms (also known as nanotriangles), hollow spherical shells (also known as nanoshells), tubes (also known as nanotubes), nanosheets, nanoplates, nanodisks, rods (also known as nanorods), and mixtures thereof. In some embodiments, the SPIONs are spherical and have an average diameter in the range of 1 to 100 nm, preferably in the range of 10 to 90 nm, 10 to 80 nm, 10 to 70 nm, 10 to 60 nm, or about 10-30 nm. In a preferred embodiment, the SPIONs are less than 90 nm in size to shift from a multi-domain to a single-domain magnetic structure. The SPIONs are aggregated, forming an interconnected network. In other words, there are no lone SPIONs which are not touching at least one other SPION in the aggregated network.

The SPIONs may be further coated with hydrophilic or hydrophobic coatings, referred to as coated SPIONs, that are conventionally known in the art. Examples of a hydrophilic coatings include, glycols, alcohols, sulfates, sulfonates, carboxylates, and phosphates. In a preferred embodiment, the hydrophilic coating is polyethylene glycol (PEG). Examples of hydrophobic coatings include, compounds with extended carbon chains such as a carbon chain having up to 30 carbon atoms, preferably 5-25 carbons, 10-20 carbons or about 15 carbons. In a preferred embodiment, the compound with a carbon chain having up to 30 carbon atoms is oleic acid or oleyl amine. In a more preferred embodiment, the compound with a carbon chain having up to 30 carbon atoms a mixture of oleic acid and oleyl amine. In a specific embodiment, the ratio of the oleic acid to the oleyl amine is in a range of 1:5 to 5:1, preferably 1:4 to 4:1, preferably 1:3 to 3:1, preferably 1:2 to 2:1, preferably 1:1. Certain other examples for coating the SPIONs include dextran, polyvinyl alcohol, Tween80®, gold nanocages, chitosan, and/or mixtures thereof. In some embodiments, the SPIONs may be coated by one or more layers, with each layer having the same or different coating.

The purpose of coating the SPIONs is to enhance the surface reactivity of the SPIONs, thereby allowing for physical/chemical attachment of the pesticide to the SPION. The coating may be any suitable coating known to one of ordinary skill in the art. The choice of the coating material is dependent on the pesticide that is to be applied. For example, when a herbicide having hydrophilic groups such as glyphosate is to be applied, a hydrophobic coating on the surface of the SPION is preferred. Also, for example, when a pesticide having hydrophobic groups such as imiprothrin or cypermethrin is to be applied, a hydrophilic coating on the surface of the SPION is preferred.

The pesticide interacts with the coating on the SPIONs via chemical/physical attractive forces. In an embodiment, the pesticide interacts with the coating SPIONs via physical interaction, which could be via van der Waals forces, hydrogen bonding, and/or hydrophobic interactions. In some other embodiments, the pesticide interacts with the coating SPIONs via chemical interaction. This interaction could be facilitated by the use of linker molecules-for example, terephthalyol chloride, 1,3,5-benzenetricarbonyl trichloride, epibromohydrin, etc.

In some embodiments, the coating is present in an amount ranging from 0.01-10 wt. %, preferably 0.1-8 wt. %, preferably 1-5 wt. %, or preferably 2-3 wt. %, based on the total weight of the coated SPIONs. In some embodiments, the coated SPIONs are present in an amount ranging from 60-99 wt. %, preferably 65-95 wt. %, preferably 70-90 wt. %, preferably 75-85 wt. %, or preferably about 80 wt. % based on the total weight of the pesticide composition.

In some embodiments, when the at least one coating is polyethylene glycol or the compound with the carbon chain having up to 30 carbon atoms. The pesticide composition is made by a method including spraying the pesticide on the coated SPIONs, and drying for at least 3 hours, preferably 10, or 24 hours to form the pesticide composition. Prior to spraying the pesticide, the pesticide is dissolved in an appropriate solvent, water, or oil (based on its solubility). After spraying the pesticide on the SPIONs, it is dried to allow for the evaporation of the solvent. The drying may be carried out for 1-10 hours, preferably 2-8 hours, preferably 3-5 hours to allow for evaporation of the solvent. The pesticide interacts with the coated SPIONs through at least one physical interaction selected from van der Waals forces, hydrogen bonding, and hydrophobic interactions.

In some embodiments, the SPIONs may be coated with polyethylene glycol and a silane. The surface functionalization of the magnetic particles or SPIONs is achieved by polycondensation of tetraethyl orthosilicate (TEOS) in the presence of polyethylene glycol coated SPIONs leading to the formation of surface-functionalized magnetic polysilane particles. Optionally, other silane precursors, apart from TEOS, that are known in the art may be used, such as tetramethyl orthosilicate, tetrapropyl orthosilicate, or tetrabutyl orthosilicate. The choice of such precursors is obvious to a person skilled in the art. Units of the silane bond to free surface hydroxyl groups on the SPIONs and/or the hydroxyl groups of the polyethylene glycol and polymerize on the surface, thereby forming a layer at least partially surrounding the SPION, preferably entirely surrounding the SPION. The polymerized silane, otherwise referred to as the polysilane or the silane coating, contains oligomers having 2-20 units, preferably 5-15, or about 10 units of the silane bonded by alternating Si—O—Si bonds.

In some embodiments, porous silicate/aluminosilicate materials may be used as well. Examples of such suitable porous silica, silicate, or aluminosilicate materials include, but are not limited to, MCM-41, MCM-48, Q-10 silica, hydrophobic silica, mesobeta, mesoZSM-5, SBA-15,

KIT-5, KIT-6, mesosilicalite, hierarchical porous silicalite, and SBA-16. Methods of obtaining the various types porous silica, silicate, or aluminosilicate material are well-known in the art [see for example Gobin, Oliver Christian “SBA-16 Materials: Synthesis, Diffusion, and Sorption Properties” Dissertation, Laval University, Ste-Foy, Quebec, Canada, January 2006, in particular section 2.2; and U.S. patent application Ser. No. 15/478,794—both incorporated herein by reference in their entireties].

The silane coating is porous on the surface of the SPION and has an average pore size of 10 to 90 nm, preferably 10 to 80 nm, preferably 10 to 70 nm, preferably 10 to 60 nm, preferably 10-30 nm, and preferably 1-10 nm. In some embodiments, the silane coating on an outer surface of the SPION has a thickness of 1 to 90 nm, preferably 1 to 80 nm, preferably 1 to 70 nm, preferably 1 to 60 nm, preferably 1-30 nm, preferably 1-10 nm, preferably 2-10 nm. The porous structure of the silane coating allows for the encapsulation of pesticides within the pores of the coating to form the pesticide composition.

In some embodiments, the SPIONs may be coated with polyethylene glycol and an aminosilane with a primary amine group. The aminosilane with a primary amine group is 3-aminopropyltriethoxysilane (APTES), however, any suitable silane with a primary amine can be used, such as 3-aminopropyltrimethoxysilane, 3-aminopropyltripropoxysilane, or 3-aminopropyltributoxysilane. The surface functionalization of the magnetic particles is achieved by polycondensation of the aminosilane in the presence of polyethylene glycol coated SPIONs leading to the formation of magnetic polysilane particles that are surface-functionalized with primary amine groups. Units of the aminosilane bond to free surface hydroxyl groups on the SPIONs and/or the hydroxyl groups of the polyethylene glycol at an alkoxy group of the amino silane and polymerize on the surface, thereby forming a layer at least partially surrounding the SPION, preferably entirely surrounding the SPION. The polymerized aminosilane, otherwise referred to as the polysilane or the aminosilane coating, contains oligomers having 2-20 units of the aminosilane bonded by alternating Si—O—Si bonds. As the bond to the hydroxyl group is through an alkoxy group of the aminosilane, the primary amine group remains unreacted and extends from the surface of the SPION.

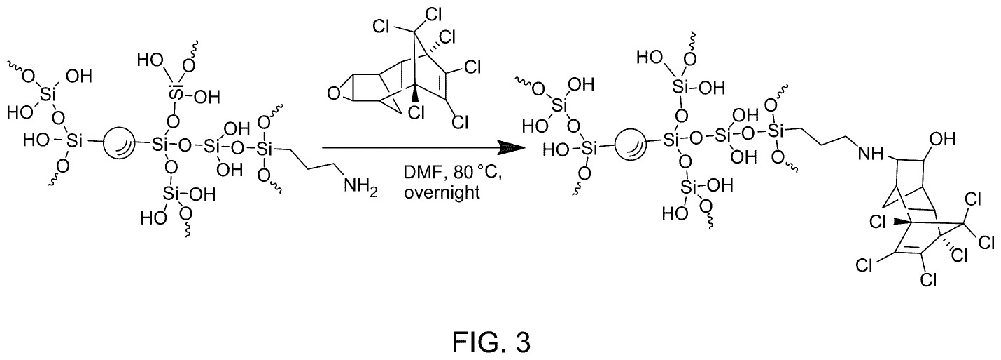

The amine functional groups present on the surface of the amino-functionalized magnetic particles can then interact with the pesticide via a chemical bond. More specifically, the pesticide is attached to the coated SPIONs by a chemical bond between the primary amine of the aminosilane and the reactive functional groups present in the pesticide. For example, for epoxide-containing pesticides, the pesticide is attached to the coated SPIONs by a chemical bond between the primary amine group of the aminosilane and the epoxide of the pesticide, an embodiment is depicted in FIG. 3. Optionally, certain linker molecules may be used (for example, terephthalyol chloride, 1,3,5-benzenetricarbonyl trichloride, epibromohydrin, etc) to facilitate the chemical attachment of the pesticide to the SPIONs.

In these embodiments, when the SPIONs are coated with polyethylene glycol and an aminosilane with a primary amine group, the pesticide composition may be prepared by dispersing the coated SPIONs in a solvent to form a dispersion. The solvent is a polar aprotic solvent. Suitable examples of polar aprotic solvents include DMF (dimethylformamide), DMPU (dimethyl pyrimidinone), DMSO (dimethyl sulfoxide), DMA (dimethylacetamide), NMP (N-methylpyrrolidone), DMAC (dimethyl acetamide), tetrahydrofuran (THF), acetonitrile, acetone, the like, and combinations thereof. In a preferred embodiment, the polar aprotic solvent is DMF. Then, the method includes mixing the epoxide-containing pesticide into the dispersion and stirring for at least 3 hours at a temperature of 50-100° C., preferably 60-90° C. or 70-80° C. In a specific embodiment, the epoxide-containing pesticide is dieldrin. The epoxide-containing pesticide is mixed to the dispersion and stirred for 3-15 hours, preferably 5-12 hours, at a temperature range of preferably 60-90° C., preferably 70-80° C. Stirring should be carried out to avoid coagulation of the magnetic particles. Finally, the method includes removing the solvent to form the pesticide composition. The solvent may be removed by evaporation (air-drying), to form the pesticide composition.

The pesticide composition, as disclosed in any of the above embodiments, demonstrates high stability in that it does not undergo sedimentation and remains dispersed in a solution for at least 30 minutes, preferably 10 hours, 24 hours, or 1 week. For example, a hydrophobic coated SPION remains stable in a hydrophobic solution and a hydrophilic coated SPION remains stable in a hydrophilic solution. Also, the pesticide composition remains stable for at least 30 days, preferably 60 days, 120 days, or 1 year under ambient conditions. In other words, the pesticide remains interacting with the coated SPIONs even after 30 days, preferably 60 days, 120 days, or 1 year under ambient conditions.

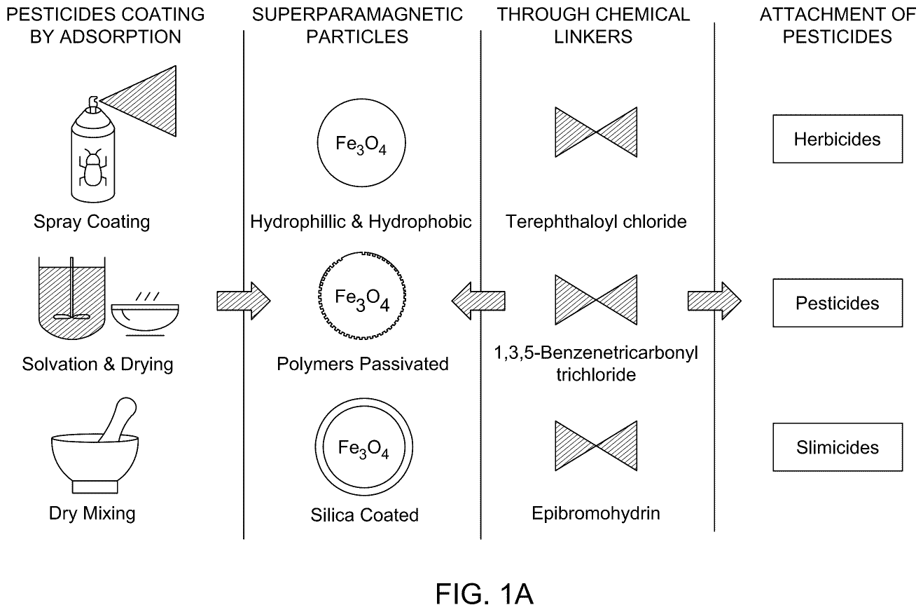

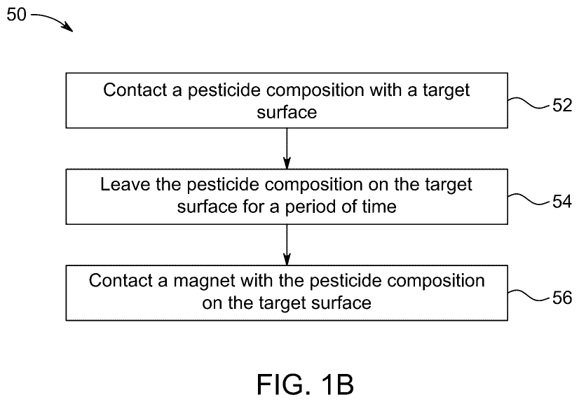

FIG. 1B illustrates a flow chart of a method 50 of applying a pesticide composition to a target surface. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes contacting the pesticide composition with the target surface. The target surface is usually the area where a pest problem occurs. The target surface may be a root zone, on foliage, under the leaves, etc. The pesticide composition may be contacted with the target surface by spraying. Different spraying techniques are known. The spray volume, the choice of nozzle used in the sprayer, the timing of the application of the pesticide composition to the target surface, the quantity of application, and coverage can be selected as needed. The sprayer may be manually operated (for example, syringes, slide pump, compression sprayer, foot operated sprayer, piston pump type, stirrup pumps, rocker sprayer) or power operated (for example, high-pressure sprayer, tractor mounted/trailed sprayer, aircraft, aerial spraying, and the like).

At step 54, the method 50 includes leaving the pesticide composition on the target surface for a period of time. The pesticide composition is left on the target surface for enough time, such as 1 hour to 100 days, preferably 1 day to 50 days or 21 to 28 days. In an embodiment, the period of time is dependent on the extent of pest manifestation/pest disease/shelf-life of the pesticide.

At step 56, the method 50 includes bringing a magnet close enough to the target surface to interact with the composition on the target surface. The magnetic particles present in the pesticide composition attract to the magnet, as a result of which, the pesticide composition attaches to the magnet. At least 90%, preferably at least 95%, 98%, 99%, or 100% of an initial amount of the pesticide composition attaches to the magnet, thereby overcoming the conventional challenges associated with pesticide disposal.

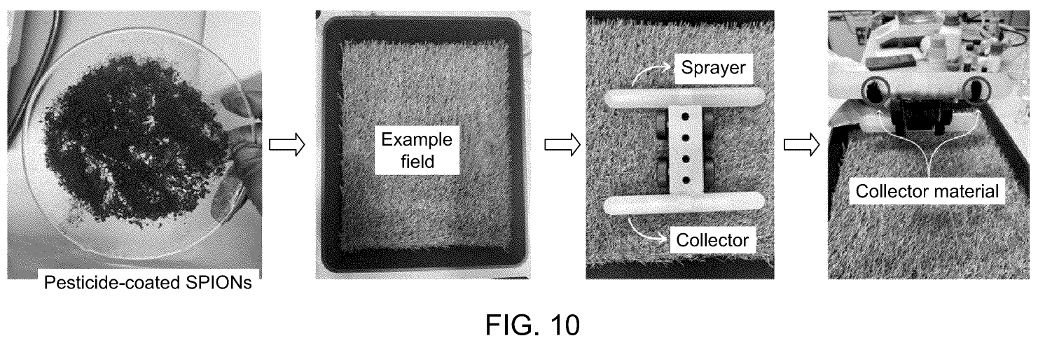

In some embodiments, the pesticide composition may be collected with the same device by which it is sprayed. See for example FIG. 10. As the pesticide composition is sprayed over the target surface, a second part of the device can pass over the sprayed area and pick up the deposited pesticide composition. Preferably, an application device is used that permits concurrent application and collection.

### EXAMPLES

The following examples demonstrate a method of applying a pesticide composition to a target surface as described herein. The examples are provided solely for illustration and are not to be construed as limitations of the present disclosure, as many variations thereof are possible without departing from the spirit and scope of the present disclosure.

### Example 1

### Research Methodology

Aspects of the present disclosure are directed towards preparing magnetic nano-pesticides by synthesizing hydrophilic and hydrophobic superparamagnetic iron oxide nanoparticles (SPIONs, Fe₃O₄). For this purpose, hydrophilic SPIONs (PEG-Fe₃O₄) were prepared by a solvothermal method using iron (III) acetylacetonate (Fe(acac)₃) as a precursor while polyethylene glycol 400 (PEG-400) as a solvent, capping, and reducing agent. Hydrophobic SPIONs (OLA-Fe₃O₄) were synthesized by the same method using a mixture of oleic acid and oleylamine. For comparison purposes, uncoated SPIONs (UC-Fe₃O₄) were also prepared by the co-precipitation method.

### Example 2

### Synthesis of Hydrophilic SPIONs

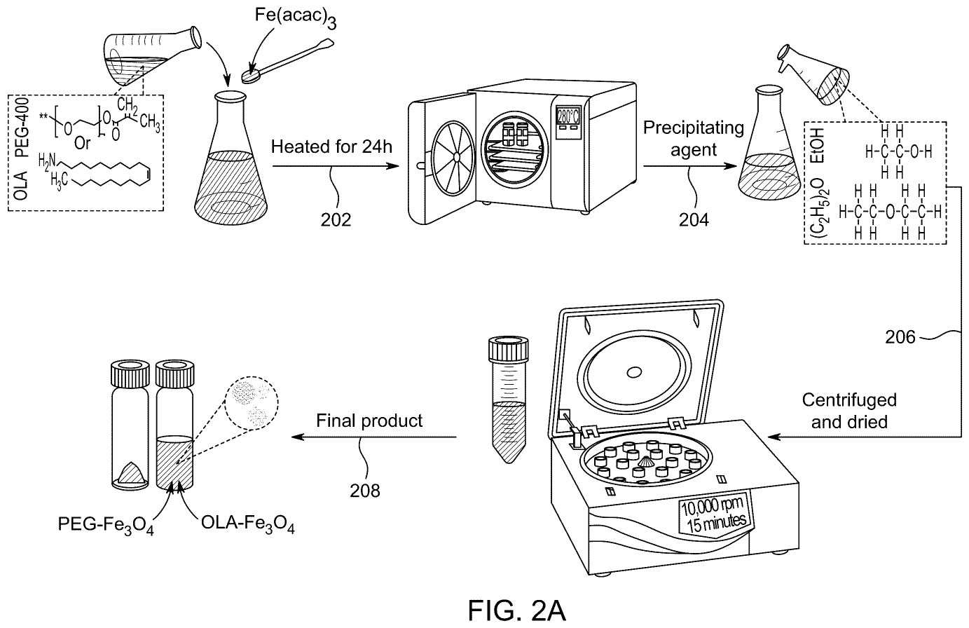

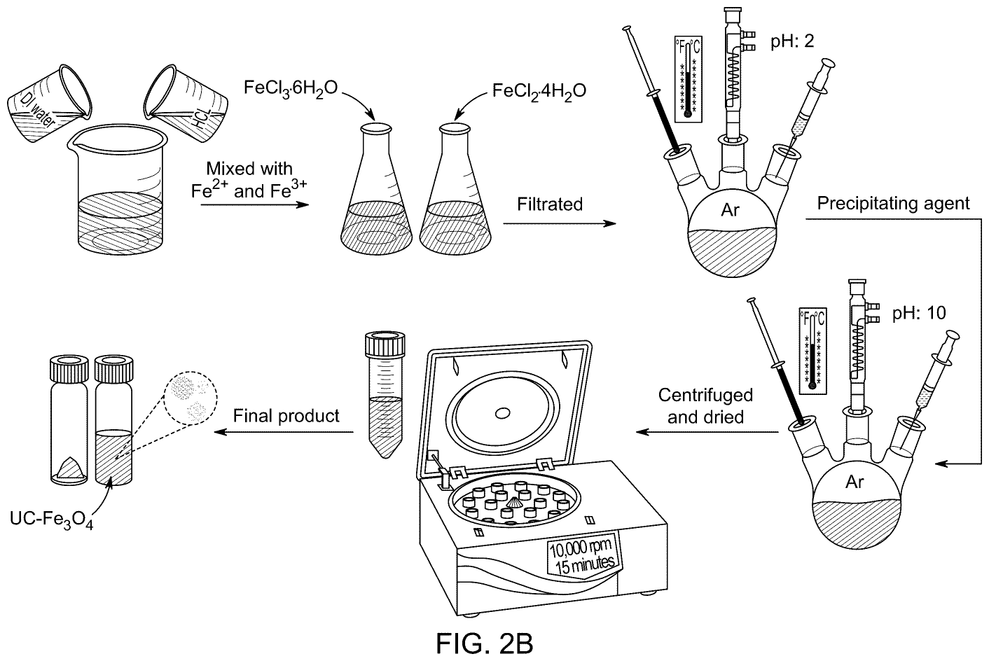

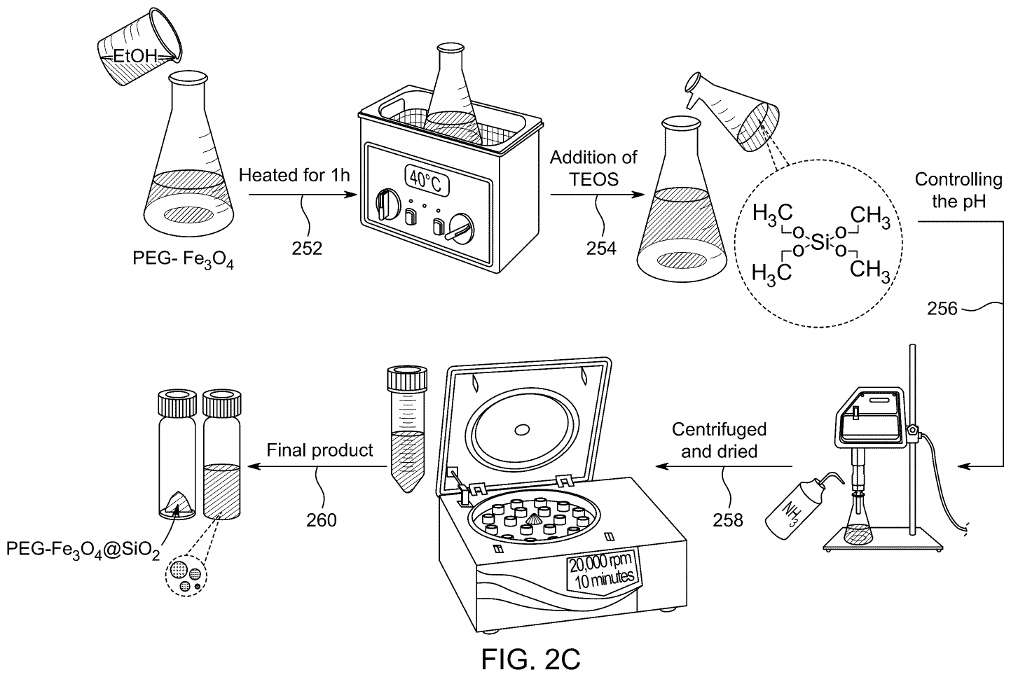

The hydrophilic SPIONs (PEG-Fe₃O₄) were prepared by a solvothermal method using PEG-400 [See Ali, S., Khan, S. A., Eastoe, J., Hussaini, S. R., Morsy, M. A., Yamani, Z. H., Synthesis, characterization, and relaxometry studies of hydrophilic and hydrophobic superparamagnetic Fe₃O₄ nanoparticles for oil reservoir applications. Colloids Surfaces A Physicochem. Eng. Asp. 2018, 543, 133-143, incorporated herein by reference in its entirety]. A schematic illustration depicting the synthesis of the hydrophilic SPIONs is depicted in FIG. 2A. In brief, an IKA ultra turrax homogenizer (T18, USA) was used to mix 12 millimoles (4.370 g) of Fe(acac)₃ and 75 g of PEG in a 125 mL polytetrafluoroethylene (PTFE) vessel for 1 h to generate a homogeneous suspension. A stainless-steel autoclave reactor (Parr, USA) having the PTFE vessel was kept in a synthetic oven at 180° C. for 24 h (202). After completion of the reaction, the mixture was cooled to room temperature. Finally, absolute ethanol and excess diethyl ether were added to precipitate the black slurry (204). The synthesized NPs were centrifuged thrice at 10,000 rpm for 10 minutes to eliminate unbound PEG-400 (206) and dried in a vacuum oven at 80° C. for 24 h (208). The final black product was labeled as PEG-Fe₃O₄.

### Example 3

### Synthesis of Hydrophobic SPIONs

A schematic illustration depicting the synthesis of the hydrophobic SPIONs is depicted in FIG. 2A. The hydrophobic SPIONs (OLA-Fe₃O₄) were synthesized by a modified solvothermal method. Briefly, 10 mmoles (3.640 g) of Fe(acac)₃ were dispersed in 50 mL of oleic acid and oleylamine (1:1) mixture using an ultra turrax homogenizer for 1 h. The obtained red suspension was transferred to the PTFE vessel and placed in a stainless-steel autoclave reactor at 200° C. for 24 h (202). After completion of the reaction, the mixture was cooled down to ambient temperature. The obtained product was precipitated (204), purified (206), and dried (208) using the same procedure as described above for the synthesis of PEG-Fe₃O₄. The final black product was labeled as OLA-Fe₃O₄.

For comparison purposes, uncoated SPIONs (UC-Fe₃O₄) were also prepared by the co-precipitation method, where iron (II) chloride and iron (III) chloride were chosen as precursors, while ammonium hydroxide (NH₄OH) was used as a reducing agent. The detailed procedure is described in Ali, S., Khan, S. A., Yamani, Z. H., Qamar, M. T., Morsy, M. A., Sarfraz, S., Shape- and size-controlled superparamagnetic iron oxide nanoparticles using various reducing agents and their relaxometric properties by Xigo acorn area. Appl. Nanosci. 2019, 9, 479-489, incorporated herein by reference in its entirety. A schematic representation for the synthesis of UC-Fe₃O₄ is demonstrated in FIG. 2B.

### Example 4

### Silane Encapsulation of PEG-Fe₃O₄

Silane-coated magnetic NPs were prepared by hydrolysis and polycondensation of tetraethyl orthosilicate (TEOS) with nucleation of formed polysilane on the surface of SPIONs, as demonstrated in FIG. 2C. The hydrolysis reaction of TEOS was catalyzed in an alkaline medium. Briefly, as-synthesized PEG-Fe₃O₄ (1.0 g) NPs were dispersed in 50 mL of deionized (DI) water followed by the addition of 1.0 g of cetyltriethylamoonium bromide (CTAB) surfactant. The mixture was stirred using a mechanical stirrer for 30 minutes (252). Then, TEOS (1.0 mL) was dissolved in 20 mL of ethanol and added to the reaction flask (254). The pH of the solution was maintained at ≥10 using NaOH (0.5 M) solution. The stirring continued for 18 hours at room temperature. The pH of the suspension was continuously monitored and adjusted again using NaOH solution followed by stirring for another 4 hours (256). Finally, the suspension was centrifuged for 15 min at 10,000 rpm (258) and washed with DI water thrice to remove unreacted material. The final black product was labeled as PEG-Fe₃O₄@SiO₂ (260).

In addition, amino-functionalized magnetic polysilane (Fe₃O₄@SiO₂-NH₂) NPs were prepared by hydrolysis and polycondensation of 3-aminopropyl triethoxysilane (APTS) instead of using TEOS by adopting the same procedure as described above for the synthesis of PEG-Fe₃O₄@SiO₂ NPs. The pesticides were coated on SPIONs by two different strategies: physical adsorption method and through chemical attachment of pesticides.

### Example 5

### Physical Adsorption of Pesticides on SPIONs

As-synthesized PEG-Fe₃O₄ and OLA-Fe₃O₄ NPs were coated with two different commercial pesticides (i.e., insecticides and herbicides) through physical adsorption by spray, solvation and drying, and dry mixing processes. The insecticides having imiprothrin (0.1% w/w) and cypermethrin (0.1% w/w) as active materials were coated on PEG-Fe₃O₄, while the herbicides having glyphosate (9% w/v) were coated on OLA-Fe₃O₄. For pesticide coating, 1.0 g of magnetic material was taken in a glass petri dish and 100 mg of pesticide (insecticides or herbicides) was coated on it by spraying technique, which was loaded/adsorbed in the micro/nanopores of SPIONs. After pesticide coating, the samples were kept drying for 6 hours inside the fume hood and then analyzed by Fourier Transform Infrared (FTIR) spectroscopy technique to confirm the coating of pesticides on the surface of SPIONs. Finally, the pesticide-coated SPIONs were applied on an example field and collected back after a certain period (6 hours, 24 hours, and one month) to prove their reusability and collection efficiency for real field application. For this purpose, an external super strong permanent magnetic rod (NdFeB, WALTX) was applied to collect magnetic pesticides.

### Example 6

### Chemical Attachment of Pesticides with SPIONs

Briefly, 40 mg of amino-functionalized magnetic polysilane (Fe₃O₄@SiO₂-NH₂) NPS were dispersed in dimethylformamide (DMF, 10 mL) using a probe sonicator for 10 minutes. Then, 20 mg of epoxide-containing insecticide (dieldrin) was added to the reaction mixture and stirred the mixture overnight at 80° C. The stirring was carried out using a mechanical stirrer instead of the magnetic stirrer plate to avoid the coagulation of magnetic particles. The DMF solvent was completely evaporated by the air-drying process. The final product was labeled as dieldrin-attached Fe₃O₄@SiO₂-NH₂ (FIG. 3).

### Example 7

### Characterization Techniques

The physical characteristics of the synthesized nanoparticles such as size, shape, and stability were characterized by X-ray Diffraction (XRD), Field Emission Scanning Electron Microscopy (FESEM), Transmission Electron Microscopy (TEM), Turbiscan Analysis, and FTIR. A Smart Lab X-ray diffractometer (Rigaku, 3-chōme-9-12 Matsubaracho, Akishima, Tokyo 196-8666, Japan) with a diffraction angle (2Θ) range of 20-70° and a scan rate of 3°/min was used to record the diffraction patterns of as-synthesized SPIONs. FTIR spectra were recorded for the synthesized samples in the range from 400-4000 cm⁻¹. The particle size, shape, and surface morphology were examined via FESEM and TEM. Prior to the imaging, a dilute suspension of each sample was prepared, placed on an SEM specimen stub, and coated by a Quorum sputter coater (Q150R-ES, manufactured by Quoram technologies, Lewes, United Kingdom). The stability of synthesized samples was examined via a Turbiscan LAB instrument using a cell made of a borosilicate glass tube (diameter 12 mm, height 140 mm). The transmitted intensity of a long sample column in the cell was recorded by an optical head using near-infrared light (850 nm). These measurements can detect particle-particle interactions and phase separation phenomena. The magnetic NPs were analyzed before and after coating with pesticides via FTIR spectroscopy to confirm the presence of pesticides on the surface of SPIONs.

### Example 8

### Characterization of the SPIONs

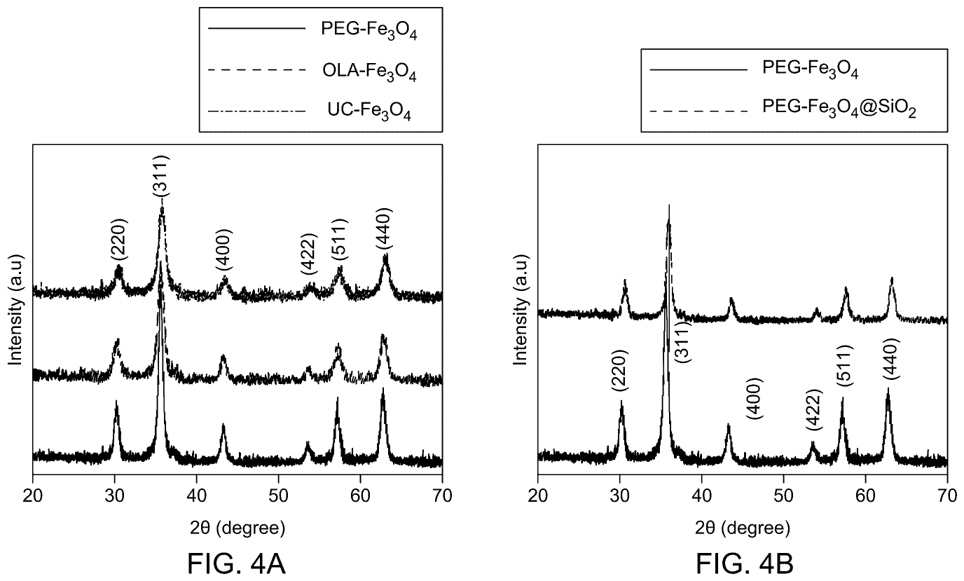

The phase purity and crystal structure of as-synthesized SPIONs were investigated through XRD analysis. FIG. 4A displays the diffraction patterns of PEG-Fe₃O₄, OLA-Fe₃O₄, and UC-Fe₃O₄ NPs. The observed diffractograms match well with the standard pattern (JCPDS card #71-6339) of the magnetite phase having a face-centered cubic structure. The six major diffraction peaks can be indexed to (220), (311), (400), (422), (511), and (440) with no impurity peaks, indicating the purity of as-synthesized samples. FIG. 4B exhibits the diffraction patterns of PEG-Fe₃O₄ and PEG-Fe₃O₄@SiO₂ NPs. The comparison indicates that there is a slight shift) (0.30° in the fcc diffraction peak (311) from 35.59° to 35.89°, which reveals the possible attachment of magnetite with polysilane NPs. However, a broad diffraction peak of polysilane at 23° was not observed due to the lower thickness of the polysilane shell on magnetite NPs.

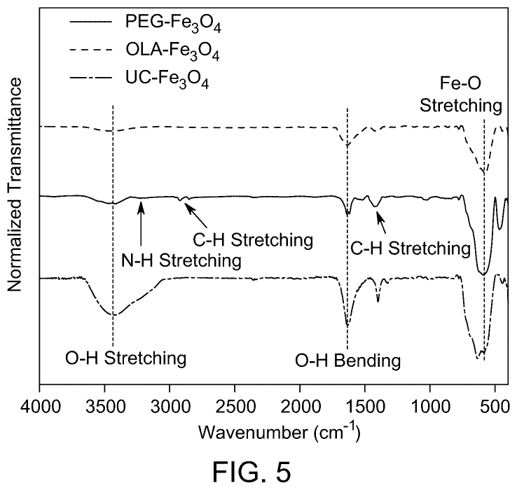

FTIR spectra of as-synthesized PEG-Fe₃O₄, OLA-Fe₃O₄, and UC-Fe₃O₄ NPs are demonstrated in FIG. 5. The spectra exhibit peaks at 3440 and 1630 cm⁻¹, which are characteristic absorption peaks of O—H stretching and bending vibrations, respectively. In addition, anoter peak that appeared at 580 cm-1 corresponds to Mₜ—O (Fe—O) stretching vibration, where Mₜ represents metal occupying the tetrahedral position, indicating an inverse spinel structure of Fe₃O₄. The C—H stretching and bending vibrations appeared at 2922 and 1400 cm⁻¹, respectively. However, N—H stretching vibration appeared at ˜3300 cm⁻¹ indicating the presence of oleylamine functionality in the case of OLA-Fe₃O₄ NPs. The comparison indicates that the concentration of O—H functional groups increased in the case of UC-Fe₃O₄ NPs confirming the presence of an oxidized surface.

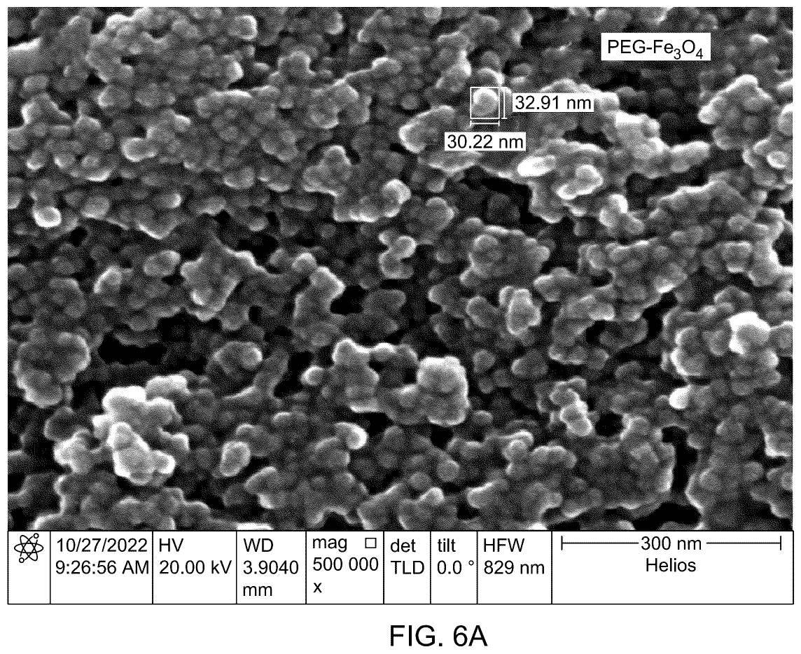

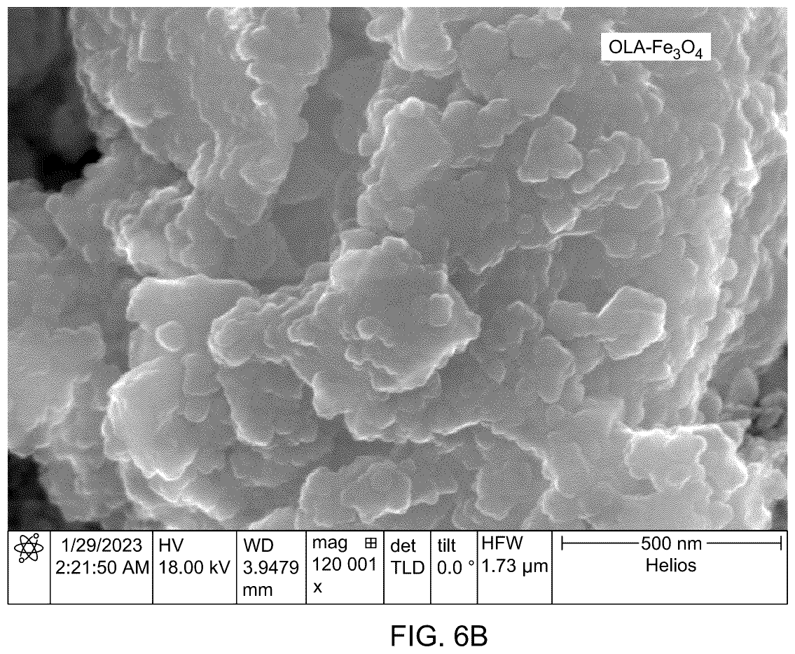

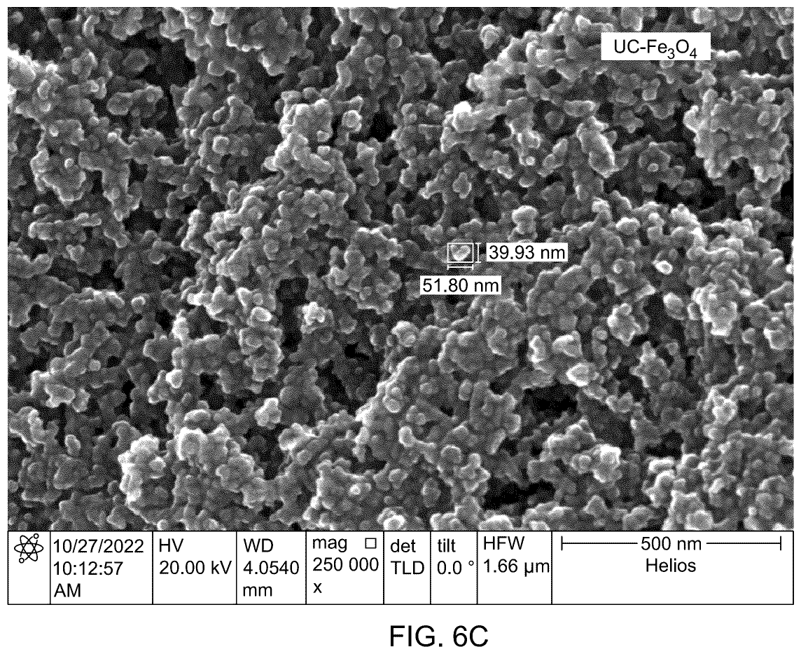

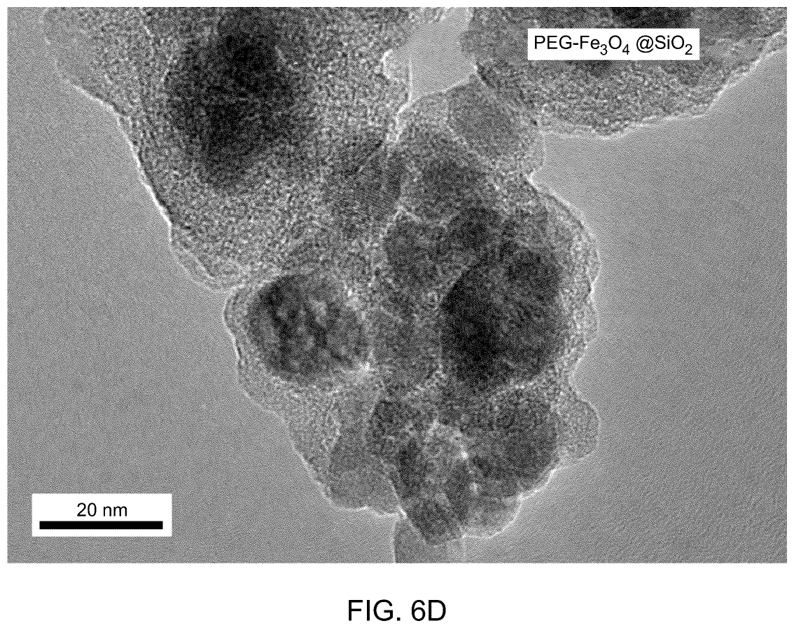

Surface morphology and particle size of as-synthesized SPIONs were examined via FESEM (Helios NanoLab G3, FEI). In order to improve the resolution, the sample's surface was coated with platinum up to a thickness of ˜2 nm. High-resolution micrographs of PEG-Fe₃O₄, OLA-Fe₃O₄, and UC-Fe₃O₄ are displayed in FIGS. 6A-6C, respectively. From the micrograph, it can be clearly seen that spherical-shaped NPs (20±2.5 nm) are formed with slight aggregation.

The spherical-shaped particles are primarily formed owing to the minimum surface-free energy. This is due to the isotropic nucleation rate per unit area at particle interfaces, which causes the surface free energy to be minimized. Hence, spherical particles are formed due to the equivalent growth rate in all directions of nucleation. FIG. 6D represents the TEM image of PEG-Fe₃O₄@SiO₂ NPs (˜25 nm). It can be seen that spherical-shaped Fe₃O₄ NPs are coated with porous polysilane having a thickness of ˜5 nm. The presence of polysilane coating will help to enhance the surface reactivity, porosity, retaining the pesticides, and chemical attachment with pesticides.

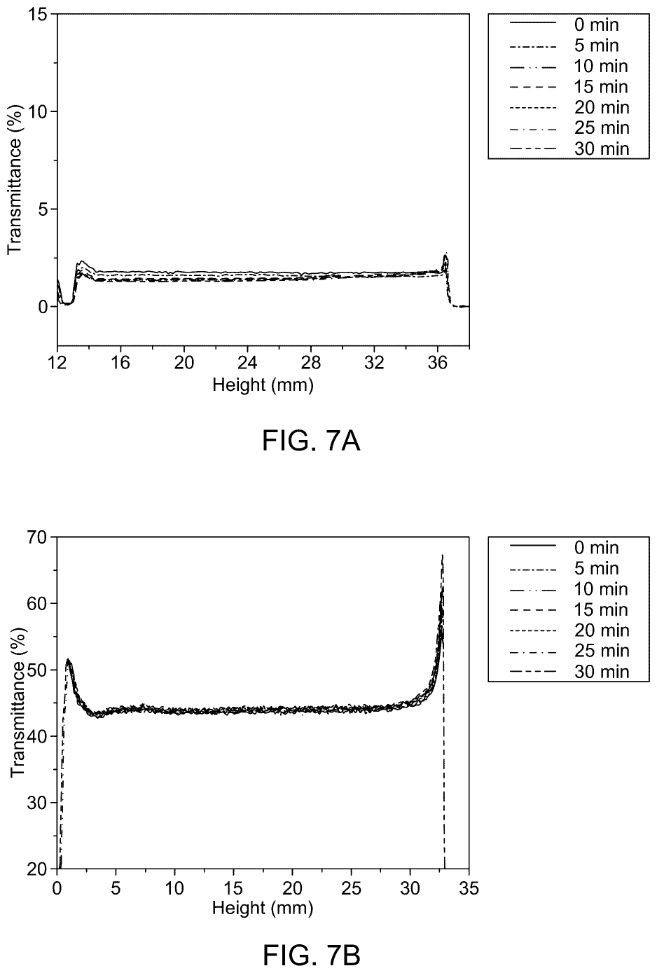

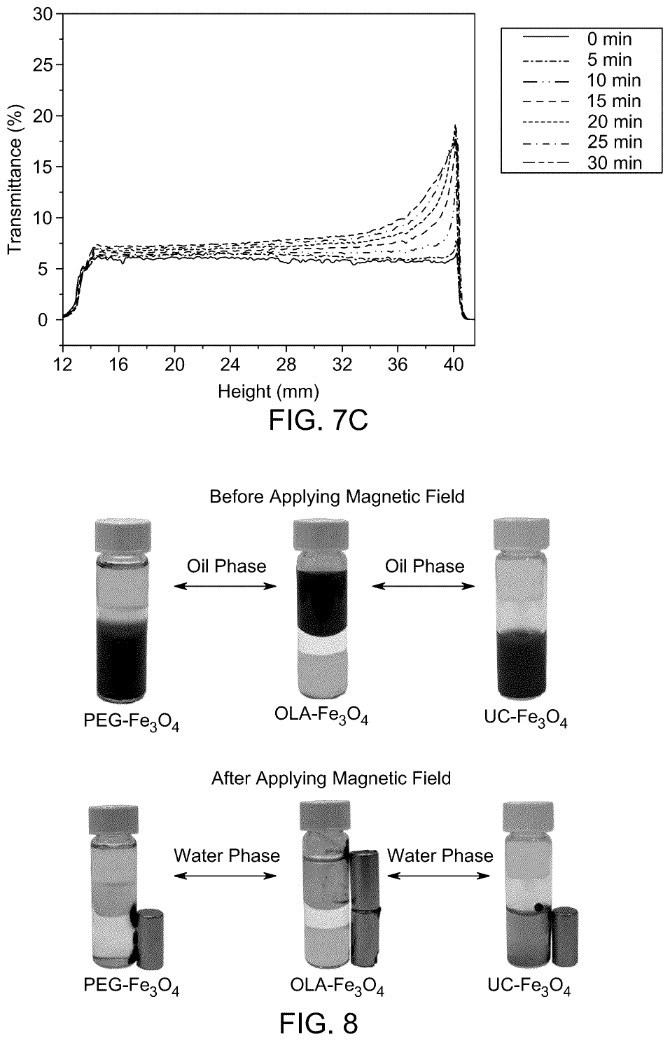

The sedimentation behavior of developed SPIONs was determined by the multiple light scattering technique (Turbiscan LAB®, Formulaction). Each sample was dispersed in a solvent (4 mL) and transferred into a cylindrical glass cell (40 mm length) at 25° C. The glass cells were completely scanned at time intervals of 5 minutes for a period of 30 minutes. The transmitted light was recorded as a function of the cell height during this time interval. The sedimentation behavior of PEG-Fe₃O₄ and UC-Fe₃O₄ NPs in DI water are depicted in FIG. 7A and FIG. 7C, respectively, while FIG. 7B demonstrates the stability of OLA-Fe₃O₄ NPs in ethanol solvent (non-aqueous phase). The comparison indicates that both PEG-Fe₃O₄ and OLA-Fe₃O₄ dispersions remained stable in their respective solvents, while UC-Fe₃O₄ NPs were found to be less stable in the aqueous phase due to the sedimentation phenomenon. This phenomenon was confirmed by observing the change in percent transmittance intensity of UC-Fe₃O₄ NPs from the top of the vial with time.

The functionality and structural stability of PEG-Fe₃O₄, OLA-Fe₃O₄, and UC-Fe₃O₄ were investigated in aqueous and non-aqueous phases (1:1), as shown in FIG. 8. The aqueous phase contains deionized (DI) water while the non-aqueous phase consists of a cyclohexane and hexadecane mixture. It was observed that PEG-Fe₃O₄ NPs were found stable and remained in the water phase which shows their hydrophilic functionality, while OLA-Fe₃O₄ NPs were found stable and remained in the oil phase which reveals their hydrophobic functionality. Moreover, the particles don't exhibit any long-term sedimentation behavior and can easily re-disperse upon removing the externally applied magnetic field. In the case of UC-Fe₃O₄, the particles became unstable and were not entirely attracted by the magnetic field because Fe₃O₄ particles are pH-dependent, and their surfaces can easily be oxidized to various iron oxides/hydroxides species in an aqueous phase (pH≥7). Based on the functionality and structural stability of PEG-Fe₃O₄ and OLA-Fe₃O₄ NPs, these particles can be promising candidates to formulate reusable magnetic pesticides.

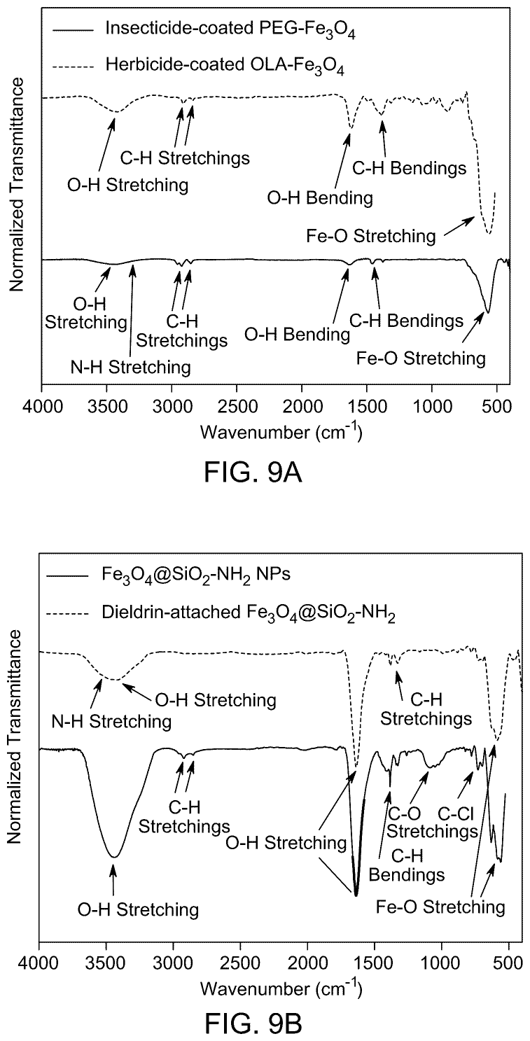

Based on the characterization of as-synthesized SPIONs, the PEG-Fe₃O₄ NPs are stable in the aqueous phase while OLA-Fe₃O₄ NPs are stable in the non-aqueous phase. Therefore, PEG-Fe₃O₄ (hydrophilic) NPs were coated with commercial insecticides having imiprothrin (0.1% w/w) and cypermethrin (0.1% w/w) as active materials, while OLA-Fe₃O₄ (hydrophobic) NPs were coated with commercial herbicides having glyphosate (9% w/v) as an active material. Both types of NPs were coated with pesticides through physical adsorption by spray, solvation and drying, and dry mixing processes. The presence of these pesticides on the particle's surface was confirmed by FTIR spectroscopy. FIG. 9A demonstrates the FTIR spectra of insecticide-coated PEG-Fe₃O₄ and herbicide-coated OLA-Fe₃O₄ NPs. The presence of C—H stretching (2922 cm⁻¹) and C—H bending (1400 cm⁻¹) vibrations confirm the insecticide-coated PEG-Fe₃O₄ NPs. While the presence of C-H stretching (2922 cm⁻¹), C—H bending (1400 cm⁻¹), and N—H stretching (3300 cm⁻¹) vibrations confirm the herbicide-coated OLA-Fe₃O₄ NPs. The comparison indicates that the pesticides were still attached to the SPIONs surface after one month of coating. Similarly, the presence of these pesticides on the particle's surface was confirmed by FTIR spectroscopy.

For the chemical attachment of insecticides with SPIONs, the amino-functionalized magnetic polysilane (Fe₃O₄@SiO₂-NH₂) NPs were attached with dieldrin (organochlorine), and their FTIR spectrum is presented in FIG. 9B. The appearance of C—O (1100 cm⁻¹) and C—Cl (730 cm⁻¹) stretching vibrations confirm the presence of dieldrin moiety on the surface of Fe₃O₄@SiO₂-NH₂ NPs. It was also observed that the dieldrin insecticides remained attached to the Fe₃O₄@SiO₂-NH₂ NPs surface after one month of coating.

### Example 9

### Application of the SPIONs

The pesticide-coated SPIONs were sprayed on an example field and collected back to prove their reusability and collection efficiency for real field applications. For this purpose, both insecticide-coated PEG-Fe₃O₄ and herbicide-coated OLA-Fe₃O₄ NPs were homogeneously sprayed on a uniform surface of artificial grass (30×30 cm) and collected back after a certain period (6 hours, 24 hours, and 1 month) by a powerful external magnetic rod (NdFeB, WALTX), as demonstrated in FIG. 10. It was observed that the pesticide-coated SPIONs become magnetic nanocarriers to take pesticides and collect them back. In order to decrease pesticide residue in the environment and confirm their reusability, the magnetic nano-pesticides were sprayed multiple times on the uniform grassy field and successfully recollected back by the external magnetic field. Finally, the collection efficiency (CE) of magnetic nano-pesticides was estimated using the following equation,

$$CE ( \% ) = {m}_{c} / {m}_{o} \times 100$$

where m_{c} is the mass of collected magnetic pesticides and mₒ is the mass of total sprayed magnetic pesticides. The results demonstrate that the maximum collection efficiency of 90-95% was achieved on the uniform grassy field, which demonstrates the successful reutilization of pesticides by employing magnetic nano-pesticides as a promising technology to minimize pesticide residue in the environment and risk to human life, animal health, and the ecosystem (FIG. 10).

Numerous modifications and variations of the present disclosure are possible in light of the above teachings. It is therefore to be understood that within the scope of the appended claims, the invention may be practiced otherwise than as specifically described herein.

1. A method of applying a pesticide composition to a target surface, comprising:
contacting the pesticide composition with the target surface; and
leaving the pesticide composition on the target surface for a period of time,
wherein the pesticide composition, comprises:
a pesticide; and
superparamagnetic iron oxide nanoparticles (SPIONs);
wherein an outer surface of the SPIONs have at least one coating selected from the group consisting of a polyethylene glycol, a compound with a carbon chain having up to 30 carbon atoms, a silane, and an aminosilane with a primary amine group to form coated SPIONs,
wherein the pesticide interacts with the at least one coating on the coated SPIONs, and
wherein the SPIONs are substantially spherical and have an average diameter of 10-30 nm.

2. The method of claim 1, wherein the pesticide composition comprises 1-20 wt. % of the pesticide, based on a total weight of the pesticide composition.

3. The method of claim 1, wherein the SPIONs are aggregated forming an interconnected network.

4. The method of claim 1, wherein the at least one coating is polyethylene glycol or the compound with the carbon chain having up to 30 carbon atoms, and
wherein the pesticide composition is made by a method comprising:
spraying the pesticide on the coated SPIONs; and
drying for at least 3 hours to form the pesticide composition.

5. The method of claim 4, wherein the pesticide interacts with the coated SPIONs through at least one physical interaction selected from van der Waals forces, hydrogen bonding, and hydrophobic interactions.

6. The method of claim 1, wherein the at least one coating is polyethylene glycol and the aminosilane with the primary amine group,
wherein the pesticide is an epoxide containing pesticide, and
wherein the pesticide composition is made by a method comprising:
dispersing the coated SPIONs in a solvent to form a dispersion;
mixing the epoxide containing pesticide into the dispersion and stirring for at least 3 hours at a temperature of 50-100° C.; and
removing the solvent to form the pesticide composition.

7. The method of claim 6, wherein the pesticide is attached to the coated SPIONs by a chemical bond between the primary amine group of the aminosilane and the epoxide group of the pesticide.

8. The method of claim 1, wherein the at least one coating is polyethylene glycol and the silane, and
wherein the silane coating has a thickness of 2-10 nm around the outer surface of the SPIONs.

9. The method of claim 8, wherein the silane coating is porous with an average pore size of 1-10 nm.

10. The method of claim 9, wherein the pesticide is present in the pores on the silane in the pesticide composition.

11. The method of claim 1, wherein the pesticide composition does not undergo sedimentation and remains dispersed in a solution for at least 30 minutes.

12. The method of claim 1, wherein the pesticide composition interacts with the at least one coating on the coated SPIONs for at least 30 days under ambient conditions.

13. The method of claim 1, wherein the pesticide is selected from the group consisting of imiprothrin, cypermethrin, dieldrin, and derivatives thereof.

14. The method of claim 1, further comprising:
bringing a magnet close enough to the target surface to interact with the pesticide composition on the target surface,
wherein the pesticide composition attaches to the magnet, and
wherein at least 90% of an initial amount of the pesticide composition present on the target surface attaches to the magnet.

15. The method of claim 14, wherein at least 95% of an initial amount of the pesticide composition present on the target surface attaches to the magnet.

16. The method of claim 1, wherein the period of time is 1 hour to 100 days.

17. The method of claim 1, wherein the compound with a carbon chain having up to 30 carbon atoms is oleic acid or oleyl amine.

18. The method of claim 1, wherein the aminosilane with a primary amine group is 3-aminopropyl triethoxysilane.
